(19) United States
(12) Patent Application Publication
(10) Pub. No.: US 2025/0232553 A1
(43) Pub. Date: Jul. 17, 2025

(54) Dynamically Defining the Region Of Interest (ROI) for Captured Images that are Processed by a Decoder in a Camera-Based Barcode-Reading Device

(71) Applicant: The Code Corporation, Murray, UT (US)

(72) Inventors: Robert E. McPherson, Heber City, UT (US); Juihsiang Ray Shih, Shrewsbury, MA (US)

(21) Appl. No.: 18/412,899

(22) Filed: Jan. 15, 2024

(51) Int. Cl. G06V 10/25; G06K 7/14; G06T 7/50; G06T 7/62; G06V 10/141; H04N 23/67

(52) U.S. Cl. CPC G06V 10/25; G06K 7/1443; G06T 7/50; G06T 7/62; G06V 10/141; H04N 23/67

(57) ABSTRACT

A camera-based barcode-reading device is configured to dynamically define the region of interest (ROI) for captured images that are processed by a decoder. In some embodiments, one or more properties (e.g., the location and the size) of the ROI can be determined dynamically by recognizing one or more decoding markers in a captured image. Once a decoding marker has been recognized in a captured image, the ROI can then be determined based on a corresponding ROI definition. In other embodiments, the ROI for a particular captured image can be determined dynamically based on a predicted location of a barcode within the captured image. The effect of dynamically determining the ROI in this way is that the ROI can essentially follow the barcode as the barcode moves across the camera's field of view.

### CROSS-REFERENCE TO RELATED APPLICATIONS

N/A

### BACKGROUND

The present disclosure is generally related to barcodes and barcode- reading devices. The term “barcode” refers to an optical machine-readable representation of information. The term “barcode-reading device” refers to any device that is capable of identifying or extracting information from barcodes. The process of identifying or extracting information from a barcode can be referred to as reading (or scanning) a barcode. When a barcode is successfully read (or scanned) by a barcode-reading device, the information that is identified or extracted from the barcode can be referred to as decoded data.

In the context of barcodes, the term “symbology” refers to a defined method of representing data using lines, spaces, shapes, and/or patterns. Broadly speaking, barcode symbologies are divided into two main types: one-dimensional (1D) barcode symbologies and two-dimensional (2D) barcode symbologies. 1D barcode symbologies represent data by varying the widths, spacings, and sizes of parallel lines. Some non-limiting examples of 1D barcode symbologies include UPC (Universal Product Code) and Code 128. 2D barcode symbologies use various shapes (e.g., rectangles, dots, hexagons) arranged in specific patterns to represent data. Some non-limiting examples of 2D barcode symbologies include QR (Quick Response) Code, Data Matrix, Maxicode, and Aztec.

As used herein, the term “1D barcode” refers to a barcode that has been encoded in accordance with a 1D barcode symbology. The term “2D barcode” refers to a barcode that has been encoded in accordance with a 2D barcode symbology. The term “barcode” may refer to either a 1D barcode or a 2D barcode.

As used herein, the term “camera-based barcode-reading device” refers to a barcode-reading device that includes a camera for capturing one or more images of a barcode to be read. Once image(s) of a barcode have been captured by the camera, a decoder processes the image(s) and attempts to decode (or, in other words, extract the information contained in) the barcode. As used herein, the term “decoder” refers to any combination of software, firmware, and/or hardware that implements one or more barcode-decoding algorithms.

A camera-based barcode-reading device can be a dedicated hardware device that is specifically designed for barcode reading. This type of device may be referred to as a dedicated barcode reader (or scanner). Alternatively, a camera- based barcode-reading device can be a general-purpose computing device that includes a camera and that is equipped with software for reading barcodes. For example, mobile computing devices (e.g., smartphones, tablet computers) are frequently utilized for reading barcodes.

As used herein, the term “barcode-reading device” includes, but is not limited to, a camera-based barcode-reading device.

As used herein, the term “camera-based barcode-reading device” includes, but is not limited to, a dedicated barcode reader (or scanner). The term “camera-based barcode-reading device” also includes, but is not limited to, a general-purpose computing device (e.g., a mobile computing device) that includes a camera and that is equipped with software for reading barcodes.

In the context of camera-based barcode-reading devices, the term “region of interest” (ROI) refers to a specified segment or portion of a captured image that the decoder processes in an attempt to decode a barcode and extract the information embedded therein. Traditionally, some barcode-reading devices have permitted users to define the ROI manually based on anticipated barcode placements and orientations. Such static, manual configurations have significant limitations. When the ROI is overly broad or not optimally positioned, the decoder might waste computational resources by processing extraneous portions of images that do not contain any part of a barcode. This can lead to inefficient operations and slow response times. Conversely, if the manually set ROI is too narrow or misaligned with respect to the barcode's actual position, there is a risk that the barcode will be partially or wholly outside the predefined ROI. In such cases, even if the barcode is clearly visible within the captured image, the decoder may entirely miss or inaccurately read the barcode, leading to missed scans or erroneous data capture. This inherent rigidity in manual ROI configurations underscores the need for more adaptive and dynamic methodologies.

The subject matter in the background section is intended to provide an overview of the overall context for the subject matter disclosed herein. The subject matter discussed in the background section should not be assumed to be prior art merely as a result of its mention in the background section. Similarly, a problem mentioned in the background section or associated with the subject matter of the background section should not be assumed to have been previously recognized in the prior art.

### SUMMARY

The present disclosure is generally related to techniques for dynamically defining the region of interest (ROI) for captured images that are processed by a decoder in a camera-based barcode-reading device.

In accordance with one aspect of the present disclosure, one or more properties (e.g., the location and the size) of the ROI can be determined dynamically by recognizing one or more decoding markers in a captured image. As used herein, the term “decoding marker” refers to a distinguishing feature or element that assists in identifying or defining the ROI within an image.

In some embodiments, a decoding marker can be externally introduced onto a barcode (or onto an object containing the barcode), such as through projection. An example of this is a light beam which, when projected onto a barcode, acts as a reference point for the ROI.

In some embodiments, a decoding marker can be intrinsic to the medium on which the barcode is printed. For example, a decoding marker can be printed alongside or around a barcode in a pre-defined location. Examples include but are not limited to geometric shapes, patterns, and/or specific words or phrases that are printed in a pre-defined location in relation to a barcode.

In some embodiments, a decoding marker can be a recognizable object that includes a barcode (e.g., a water bottle, wristband, book, ticket, ID badge). In such embodiments, the shape, size, or other unique attributes of the recognizable object can act as a reference for dynamically setting the ROI.

A decoding marker can be associated with a specific ROI definition. Once a decoding marker has been recognized in a captured image, the ROI can then be determined based on the corresponding ROI definition. As one example of an ROI definition, the ROI can be defined as a geometric shape (e.g., a rectangle) of predefined size, where the decoding marker is at the center of the rectangle. As another example of an ROI definition, the ROI can be defined as a geometric shape (e.g., a rectangle) around the decoding marker. The user of a barcode-reading device can be permitted to define decoding marker(s) and corresponding ROI definition(s) that are utilized by the barcode-reading device. The ROI definition can vary based on the type of decoding marker.

A barcode-reading device in accordance with the present disclosure can include a camera that is configured to capture images, a decoder that is configured to process captured images to decode barcodes, and a pre-processing module that is configured to dynamically determine the ROI for captured images. The pre-processing module can be configured to define the ROI for a specific captured image based at least in part on a decoding marker in the specific captured image and an ROI definition that is associated with the decoding marker.

For example, suppose that the decoding marker is a light beam and the corresponding ROI definition is a geometric shape (e.g., a rectangle) of predefined size, where the light beam is at the center of the geometric shape. In this example, the pre-processing module can be configured to process a captured image for the purpose of trying to recognize a light beam in the image. If the pre-processing module recognizes a light beam in the image, then the pre-processing module can define the ROI in accordance with the corresponding ROI definition: namely, as the applicable geometric shape of predefined size, where the light beam is at the center of the geometric shape. The ROI (or, in other words, the portion of the image corresponding to this geometric shape) can then be passed to the decoder for processing.

As another example, suppose that the decoding marker is a specific object (e.g., a water bottle), and the corresponding ROI definition is a geometric shape (e.g., a rectangle) around the object. In this example, the pre-processing module can be configured to process a captured image for the purpose of trying to determine whether the object (e.g., the water bottle) is present in the image. If the pre-processing module recognizes the object in the image, then the pre-processing module can draw the corresponding geometric shape around the object and set the ROI equal to this geometric shape. The ROI (or, in other words, the portion of the image corresponding to this geometric shape) can then be passed to the decoder for processing.

In some embodiments, the camera focus can be adjusted based on the location of the decoding marker within a captured image. When the pre-processing module detects a decoding marker, the pre-processing module can send a signal to the camera to adjust the focus, ensuring that subsequent image captures provide even clearer images of the ROI. Adjusting the focus in this way can be useful when an image includes a plurality of different objects (and possibly a plurality of different barcodes) of different sizes, which may be located at different focal distances relative to the camera. In this situation, the decoding marker can be used to indicate where the camera should be focused, thereby increasing the likelihood that the ROI in subsequent captured images will be in focus.

Another aspect of the present disclosure is generally related to dynamically determining the ROI in a scenario where the barcode is in motion relative to the barcode-reading device. In this type of scenario, the ROI for a particular captured image can be determined dynamically based on a predicted location of a barcode within the captured image. The effect of dynamically determining the ROI in this way is that the ROI can essentially follow the barcode as the barcode moves across the camera's field of view.

The predicted location of the barcode can be based on the size, shape, and estimated velocity (where velocity includes speed and direction) of the barcode. In some embodiments, the estimated velocity of the barcode can be determined from reference points indicating where certain features of the barcode are located in previously processed images and timestamps corresponding to the previously processed images.

For example, suppose that the camera within a barcode-reading device captures a plurality of images that show a barcode moving across the camera's field of view. Reference points can be determined indicating where the barcode is located in a first image and in a second image. The pre-processing module can then use these reference points, along with timestamps corresponding to the first image and the second image, to estimate the velocity (speed and direction) of the barcode. The pre-processing module can then make a prediction about where the barcode will be located in a third image. This prediction can be based on the size, shape, and estimated velocity of the barcode. The pre-processing module can then set the ROI for the third image equal to a subset of the entire image (i.e., something less than the entire image), based on the prediction about where the barcode will be located in the third image. The pre-processing module can then pass only the ROI for the third image to the decoder for processing (instead of passing the entire third image to the decoder).

In some embodiments, the ROI can include a tolerance area. In other words, the size of the ROI can be somewhat larger than the size of the barcode. Having a tolerance area can account for potential errors in the predicted location of the barcode. The tolerance area makes it more likely that even if the barcode's predicted location is slightly off, the actual location of the barcode will still likely fall within the ROI.

Dynamically determining the ROI based on the predicted location of a barcode can be especially useful in a scenario where a barcode-reading device is stationary and barcodes are moving at constant velocity. An example of such a scenario is where barcodes are located on objects that are moving along a conveyor belt and a fixed-mount barcode-reading device is positioned to read the barcodes.

In some embodiments, the barcode presentation rate can also be substantially constant. In this context, the term “barcode presentation rate” can refer to the rate at which new barcodes appear in the camera's field of view. An example of such a scenario is where barcodes are located on objects that are moving along a conveyor belt and new objects are placed on the conveyor belt at a substantially constant rate.

In embodiments where the barcode presentation rate is substantially constant, the ROI for a captured image can sometimes be based on an estimated barcode presentation rate. For example, if the barcode presentation rate is substantially constant, the ROI for a particular captured image can be determined based on an estimate of when a new barcode is going to appear in the camera's field of view.

Dynamically determining the ROI based on the predicted location of a barcode can also be useful in a scenario where an object includes multiple barcodes. The user can specify characteristic(s) of a desired barcode (e.g., symbology). The pre-processing module can set the ROI so that it includes the desired barcode and excludes other barcodes.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description that follows. Features and advantages of the disclosure may be realized and obtained by means of the systems and methods that are particularly pointed out in the appended claims. Features of the present disclosure will become more fully apparent from the following description and appended claims, or may be learned by the practice of the disclosed subject matter as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. Understanding that the drawings depict some example embodiments, the embodiments will be described and explained with additional specificity and detail through the use of the accompanying drawings in which:

FIG. 1 illustrates an example of a barcode-reading device in which at least some of the techniques disclosed herein can be utilized.

FIG. 2 illustrates an example of a decoding marker and a region of interest (ROI) definition corresponding to the decoding marker.

FIG. 3 illustrates another example of a decoding marker and a ROI definition corresponding to the decoding marker.

FIG. 4 illustrates another example of a decoding marker and a ROI definition corresponding to the decoding marker.

FIGS. 5A and 5B illustrate an example showing how the focus of the camera within a barcode-reading device can be adjusted based on the location of the decoding marker within a captured image.

FIG. 6 is a flow diagram that illustrates an example of a method for dynamically determining the ROI for captured images.

FIG. 7 illustrates another example of a barcode-reading device in which at least some of the techniques disclosed herein can be utilized.

FIGS. 8A through 8D illustrate an example showing how a pre-processing module in a camera-based barcode-reading device can dynamically determine the ROI for captured images as objects move across the camera's field of view.

FIGS. 9A through 9C illustrate another example showing how a pre-processing module in a camera-based barcode-reading device can dynamically determine the ROI for captured images as an object moves across the camera's field of view.

FIG. 10 is a flow diagram that illustrates another example of a method for dynamically determining the ROI for captured images.

### DETAILED DESCRIPTION

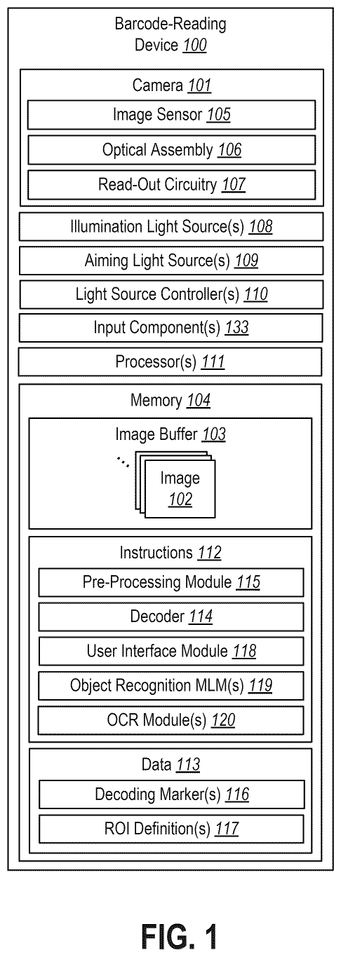

FIG. 1 illustrates an example of a barcode-reading device 100 in which at least some of the techniques disclosed herein can be utilized. The barcode- reading device 100 includes a camera 101 that is configured to capture images 102. The camera 101 is a digital camera, and the images 102 captured by the camera 101 are digital images. The barcode-reading device 100 is configured to dynamically define the region of interest (ROI) for captured images 102.

The images 102 captured by the camera 101 can be stored in an image buffer 103. The image buffer 103 is a storage area within the memory 104 where captured images 102 can be stored prior to processing.

The camera 101 includes an image sensor 105. The image sensor 105 may alternatively be referred to as an imager, a photosensor array, a photodetector array, a pixel sensor array, etc. The image sensor 105 can be a solid-state device that is configured to detect and convey information used to make an image 102. The image sensor 105 can include a relatively large number of light-sensitive pixels that are arranged in horizontal rows and vertical columns. The image sensor 105 can be a charge-coupled display (CCD) image sensor, a complementary metal-oxide-semiconductor (CMOS) image sensor, or another type of image sensor.

The camera 101 includes an optical assembly 106 including one or more lenses. The lens(es) within the optical assembly 106 can be configured to receive light reflected from objects within the field of view of the camera 101 and focus this reflected light onto the image sensor 105. The camera 101 also includes read-out circuitry 107 that is configured to electronically read the pixels within the image sensor 105 to provide an image 102 (i.e., a two-dimensional array of image data).

The barcode-reading device 100 also includes one or more light sources. In some embodiments, the barcode-reading device 100 can include at least two different types of light sources: one or more illumination light sources 108, and one or more aiming light sources 109. The illumination light source(s) 108 are configured to provide illumination for a target area within the field of view of the camera 101. The illumination light source(s) 108 help ensure that the camera 101 has sufficient lighting to capture clear images 102, even in low ambient light conditions. The aiming light source(s) 109 provide a targeting mechanism, casting a focused beam or pattern to help the user correctly position the barcode-reading device 100. The barcode-reading device 100 also includes one or more light source controllers 110 that manage the activation and deactivation of the illumination light source(s) 108 and/or the aiming light source(s) 109.

The barcode-reading device 100 includes one or more processors 111 and memory 104 that is communicatively coupled to the processor(s) 111. Broadly speaking, the memory 104 includes instructions 112 and data 113. The instructions 112 are executable by the processor(s) 111 to implement some or all of the methods, steps, operations, actions, or other functionality that is disclosed herein in connection with the barcode-reading device 100. Executing the instructions 112 can involve the use of the data 113 that is stored in the memory 104.

The instructions 112 within the memory 104 include a decoder 114. In some embodiments, the decoder 114 can be configured to perform at least two functions: identification and decoding. Barcode identification can involve the use of advanced pattern recognition techniques, which can distinguish barcodes from other visual elements in an image 102. Once a potential barcode pattern is identified, the decoder 114 can attempt to interpret the encoded information within the identified barcode pattern using one or more barcode-decoding algorithms. In some embodiments, the decoder 114 can be configured to implement a plurality of different barcode-decoding algorithms that are tailored for different types of barcode symbologies.

The instructions 112 within the memory 104 also include a pre-processing module 115. The pre-processing module 115 is configured to dynamically determine the region of interest (ROI) for at least some of the captured images 102. As discussed above, the ROI indicates what portion of a captured image 102 is passed to the decoder 114 for processing.

In the depicted embodiment, the pre-processing module 115 dynamically determines the ROI for a specific captured image 102 based at least in part on a decoding marker 116 in the captured image 102 and an ROI definition 117 that is associated with the decoding marker 116. As indicated above, decoding markers 116 are distinguishing features or characteristics that assist in identifying or defining the ROI within an image 102. Once a decoding marker 116 has been recognized in a captured image 102, the ROI can then be determined based on the corresponding ROI definition 117. Some examples of decoding markers 116 and ROI definitions 117 will be described in greater detail below.

The instructions 112 within the memory 104 also include a user interface module 118. In general terms, the user interface module 118 receives and processes user input that controls the operation of one or more aspects of the barcode-reading device 100. In some embodiments, the user interface module 118 receives user input defining decoding marker(s) 116 and corresponding ROI definition(s) 117. The user input can be entered via input component(s) 133. Some non-limiting examples of input component(s) 133 include a button, a switch, a keypad, a trigger mechanism, a touchscreen, etc.

There are a variety of ways that the pre-processing module 115 can recognize decoding markers 116 in captured images 102. For example, if a decoding marker 116 has a particular geometric shape (e.g., rectangle, circle, triangle), geometric pattern recognition can be applied. If a decoding marker 116 has a distinct level of brightness or contrast in comparison to the surrounding area, it can be isolated using contrast-based segmentation techniques. If there is a known template (e.g., shape, pattern, or object) for a decoding marker 116, template matching techniques can search an image 102 for areas that match the template.

In some embodiments, the pre-processing module 115 can use machine learning methods to recognize decoding markers 116 in captured images 102. In such embodiments, the barcode-reading device 100 can include one or more machine learning models (MLMs) that have been trained to recognize certain objects in captured images 102. Such machine learning models may be referred to herein as object recognition MLMs 119.

As noted above, a decoding marker 116 can sometimes include specific words or phrases. In such embodiments, the pre-processing module 115 can utilize one or more optical character recognition (OCR) modules 120 that are configured to recognize these words or phrases.

In alternative embodiments, at least some of the components of the barcode-reading device 100 can be distributed across multiple devices. For instance, in one possible alternative embodiment, at least some of the components (e.g., the pre-processing module 115, the decoder 114, the object recognition MLM(s) 119, and/or the OCR module(s) 120) can be located on a remote device (or combination of remote devices) that is/are communicatively coupled to the barcode-reading device 100. In such an embodiment, images 102 captured by the camera 101 can be transferred to the remote device(s) for processing.

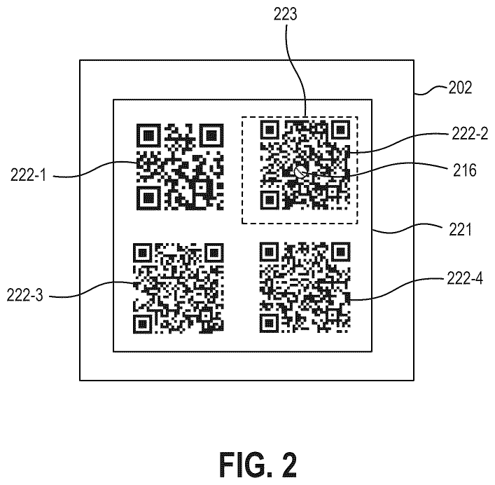

Several different examples of decoding markers 116 and accompanying ROI definitions 117 will now be described in connection with FIGS. 2-4. For the sake of simplicity, the ROI is defined as a rectangle in each of these examples. However, those skilled in the art will recognize that an ROI as disclosed herein can be any suitable geometric shape. For example, the ROI could be circular, oval, triangular, polygonal, or any other shape that best suits the specific requirements of the barcode(s) being read.

FIG. 2 illustrates an image 202 of an object 221 that includes a plurality of barcodes 222-1, 222-2, 222-3, 222-4. In this example, the decoding marker 116 is a light beam 216 (e.g., a laser beam) that is projected onto the object 221, and the accompanying ROI definition 117 is a rectangle of a pre-defined size. Thus, in this example, when the pre-processing module 115 detects the light beam 216 in the image 102, the pre-processing module 115 then defines the ROI 223 as a rectangle that is centered on the light beam 216 and that has the pre-defined size. In some embodiments, the light beam 216 that serves as the decoding marker 116 can be projected onto the barcode 222-2 by the aiming light source(s) 109 in the barcode-reading device 100.

As an alternative to the example shown in FIG. 2, the ROI could be defined such that the center of the rectangle is offset by a certain amount (in the x-direction and/or in the y-direction) relative to the light beam 216.

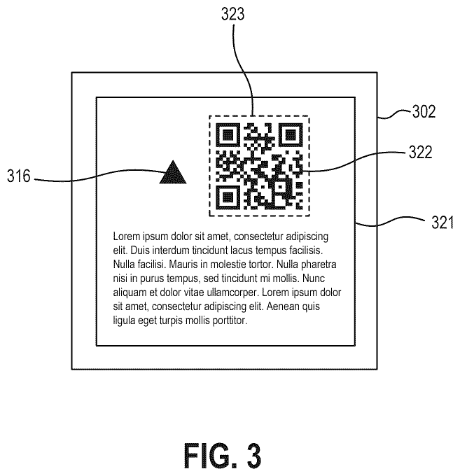

FIG. 3 illustrates another image 302 of an object 321 that includes a barcode 322. In this example, the decoding marker 116 is intrinsic to a medium on which the barcode 322 is printed. More specifically, the decoding marker 116 is a triangle 316, which is printed to the left side of the barcode 322. The accompanying ROI definition 117 in this example is a rectangle that is offset to the right of the triangle 316 by a certain pre-defined amount. Thus, in this example, when the pre-processing module 115 recognizes the triangle 316 in the image 302, the pre-processing module 115 finds a point in the image 302 that is offset to the right of the triangle 316 by the pre-defined amount, and then defines the ROI 323 as a rectangle of a pre-defined size that is centered on this point.

As an alternative to the example shown in FIG. 3, the ROI definition 117 could specify an offset in a different direction from the triangle 316. As another alternative, the decoding marker 116 could be a specific word or phrase (e.g., the phrase “SCAN HERE”) instead of a recognizable shape like the triangle 316.

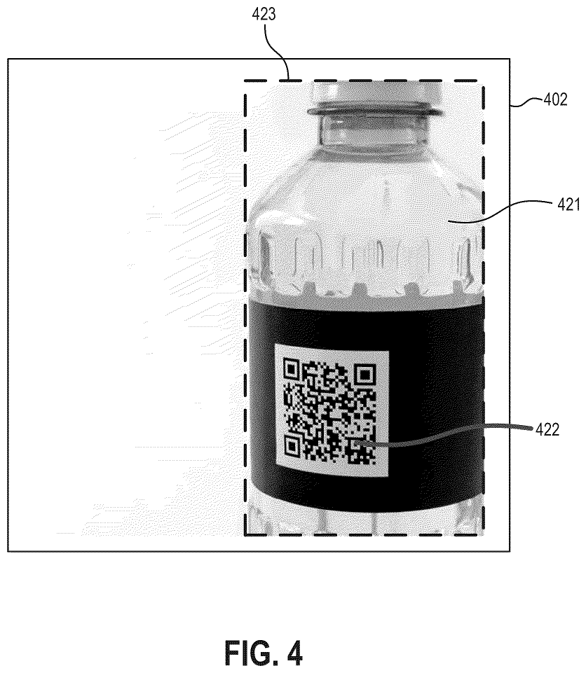

FIG. 4 illustrates another image 402 of an object 421 (specifically, a water bottle) that includes a barcode 422. In this example, the decoding marker 116 is the object 421 itself, and the accompanying ROI definition 117 is a rectangle that encompasses the object 421. Thus, in this example, when the pre-processing module 115 detects the object 421 in the image 402, the pre-processing module 115 defines the ROI 423 as a rectangle that encompasses the object 421. Alternatively, instead of using a predefined geometric shape like a rectangle, the ROI could be determined based on the actual contour of the object 421. In other words, the shape of the ROI could match the shape of the object 421 (as closely as possible).

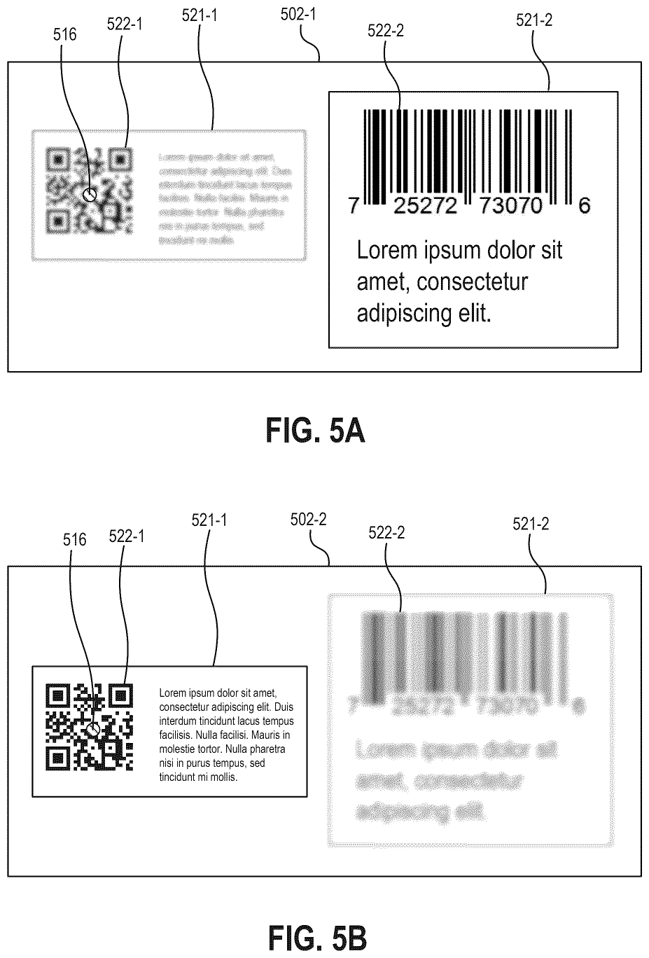

As noted above, in some embodiments, the focus of the camera 101 can be adjusted based on the location of a decoding marker 116 within a captured image 102. FIGS. 5A and 5B illustrate an example showing how this can occur.

FIG. 5A illustrates a first image 502-1 that includes two objects: a first object 521-1 and a second object 521-2. The first object 521-1 includes a first barcode 522-1, and the second object 521-2 includes a second barcode 522-2. In this example, it will be assumed that the first object 521-1 is positioned farther away from the camera 101 than the second object 521-2, and that the camera 101 is initially focused on the second object 521-2. Consequently, the second barcode 522-2 on the second object 521-2 is in focus whereas the first barcode 522-1 on the first object 521-1 is out of focus.

A decoding marker 116 is located on the first barcode 522-1 on the first object 521-1. In the depicted example, the decoding marker 116 is a light beam 516 (e.g., a laser beam) that is projected onto the first object 521-1. Alternatively, however, a different type of decoding marker 116 could be used.

In response to detecting the light beam 516, the pre-processing module 115 can cause the focus of the camera 101 to be adjusted so that the camera 101 is focused on the part of the first image 502-1 where the light beam 516 is detected. In the present example, this would cause the camera 101 to be focused on the first barcode 522-1 located on the first object 521-1.

FIG. 5B illustrates a second image 502-2 of the same two objects 521-1, 521-2. The second image 502-2 is captured after the first image 502-1, and after the focus of the camera 101 has been adjusted to focus on the part of the first object 521-1 where the light beam 516 is detected in the first image 502-1. Thus, the first barcode 522-1 is in focus in the second image 502-2, whereas the second barcode 522-2 is out of focus.

Adjusting the focus of the camera 101 in this way can improve the performance of the decoder 114. Because the first barcode 522-1 is out of focus in the first image 502-1, the decoder 114 may not be able to decode the first barcode 522-1 in the first image 502-1. Adjusting the focus of the camera 101 can increase the likelihood that the decoder 114 will be able to decode the first barcode 522-1 by providing the decoder 114 with an image 502-2 where the first barcode 522-1 is in focus.

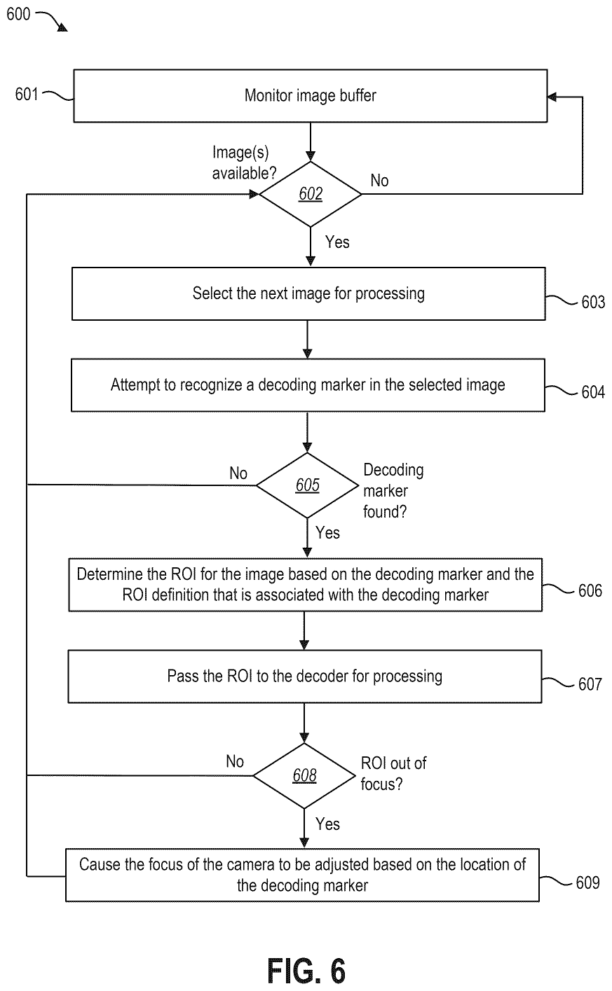

FIG. 6 is a flow diagram that illustrates an example of a method 600 for dynamically determining the ROI for captured images 102. The method 600 can be performed by the pre-processing module 115 within the barcode-reading device 100. In some embodiments, the method 600 can be performed in response to user input that initiates barcode reading.

In some embodiments, the camera 101 can be configured to continuously capture images 102 in response to receiving user input that initiates barcode reading. The images 102 can be stored in an image buffer 103, and the pre-processing module 115 can be configured to sequentially process the images 102 in the image buffer 103.

At 601, the pre-processing module 115 monitors the image buffer 103. At 602, a determination is made about whether any images 102 are available for processing. If not, then the method 600 returns to 601. However, if at least one image 102 is available for processing, the method 600 proceeds to 603. At 603, the pre-processing module 115 selects the next image 102 for processing.

At 604, the pre-processing module 115 attempts to recognize a decoding marker 116 in the selected image 102. The specific action(s) taken at 604 can depend on the type of decoding marker 116 that has been defined. For example, if the decoding marker 116 is a light beam (such as the light beam 216 shown in FIG. 2) that is projected onto a barcode, then the pre-processing module 115 searches for a light beam in the selected image 102. If the decoding marker 116 is a specific word or phrase, then the pre-processing module 115 searches for that word or phrase in the selected image 102 (possibly utilizing the OCR module(s) 120). If the decoding marker 116 is a specific shape (e.g., a circle, a pentagon, a hexagon), then the pre-processing module 115 searches for that shape in the selected image 102. If the decoding marker 116 is a specific object (e.g., a water bottle), then the pre-processing module 115 searches for that object in the selected image 102 (possibly utilizing the object recognition MLM(s) 119).

In some embodiments, the user can define a single decoding marker 116, and the pre-processing module 115 can search for that specific decoding marker 116. Alternatively, in other embodiments, the user can define a plurality of possible decoding markers 116. In such embodiments, the pre-processing module 115 can search for any of the defined decoding markers 116 in the selected image 102.

At 605, a determination is made about whether a decoding marker 116 has been found in the captured image 102. If not, then in some embodiments the method 600 returns to 602. Alternatively, the ROI for the image 102 can be set equal to the entire image 102, and the entire image 102 can be passed to the decoder 114 for processing.

If at 605 it is determined that a decoding marker 116 has been found in the captured image 102, then the method 600 proceeds to 606. At 606, the pre-processing module 115 determines the ROI for the image 102 based on the decoding marker 116 that is found at 605 and an ROI definition 117 that is associated with the decoding marker 116. In other words, as discussed above in connection with the examples shown in FIGS. 2-4, one or more properties (e.g., location and size) of the ROI can depend on both the location of the decoding marker 116 in the image 102 and the ROI definition 117 that is associated with the decoding marker 116.

At 607, the pre-processing module 115 passes the ROI (determined at 606) to the decoder 114 for processing. The pre-processing module 115 does not pass the entire image 102 to the decoder 114 for processing. In particular, the pre- processing module 115 does not pass to the decoder 114 region(s) of the image 102 outside of the ROI. In some embodiments, the pre-processing module 115 passes only the ROI determined at 606 to the decoder 114 for processing.

At 608, a determination is made about whether the ROI is out of focus. If the ROI is not out of focus, then the method 600 returns to 602 and proceeds as described above. However, if at 608 it is determined that the ROI is out of focus, then the method 600 proceeds to 609.

At 609, the pre-processing module 115 can cause the focus of the camera 101 to be adjusted based on the location of the decoding marker 116. More specifically, the pre-processing module 115 can cause the focus of the camera 101 to be adjusted to focus on the part of the image 102 where the decoding marker 116 was found in the image 102 that was just processed. The method 600 then returns to 602 and proceeds as described above.

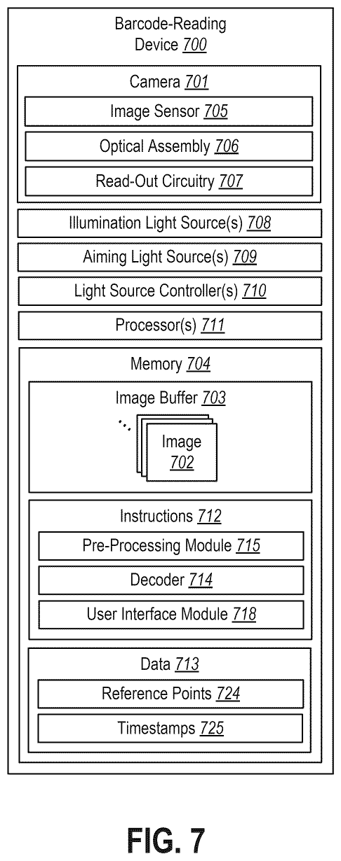

FIG. 7 illustrates another example of a barcode-reading device 700 in which at least some of the techniques disclosed herein can be utilized. The barcode-reading device 700 is similar in some respects to the barcode-reading device 100 described previously. For example, the barcode-reading device 700 includes a camera 701 including an image sensor 705, an optical assembly 706, and read-out circuitry 707. The barcode-reading device 700 also includes illumination light source(s) 708, aiming light source(s) 709, and light source controller(s) 710. The barcode-reading device 700 also includes processor(s) 711 and memory 704 that is communicatively coupled to the processor(s) 711. The memory 704 includes an image buffer 703, instructions 712, and data 713. The image buffer 703 includes images 702 captured by the camera 701. The instructions 712 include a pre-processing module 715, a decoder 714, and a user interface module 718. It can be assumed that these components of the barcode-reading device 700 are similar to the corresponding components of the barcode-reading device 100 described previously, unless indicated otherwise below.

Like the pre-processing module 115 described previously, the pre-processing module 715 is configured to dynamically determine the region of interest (ROI) for at least some of the captured images 702. In the depicted embodiment, however, the pre-processing module 715 dynamically determines the ROI for a specific captured image 702 based at least in part on a predicted location of a barcode within the captured image 702.

The predicted location of a barcode in an image 702 can include prediction(s) about where one or more features of the barcode will be located in the image 702. For example, with respect to a barcode that has a rectangular shape, the predicted location of the barcode in an image 702 can include predictions about where the four corners of the rectangular barcode will be located in the image 702.

As noted above, the predicted location of a barcode can be based on the size, shape, and estimated velocity (speed and direction) of the barcode. In some embodiments, the estimated velocity of a barcode can be determined by the pre-processing module 715. To determine the estimated velocity of a barcode, the pre-processing module 715 can utilize reference points 724 indicating where certain features of the barcode are located in previously processed images 702 and timestamps 725 corresponding to the previously processed images 702.

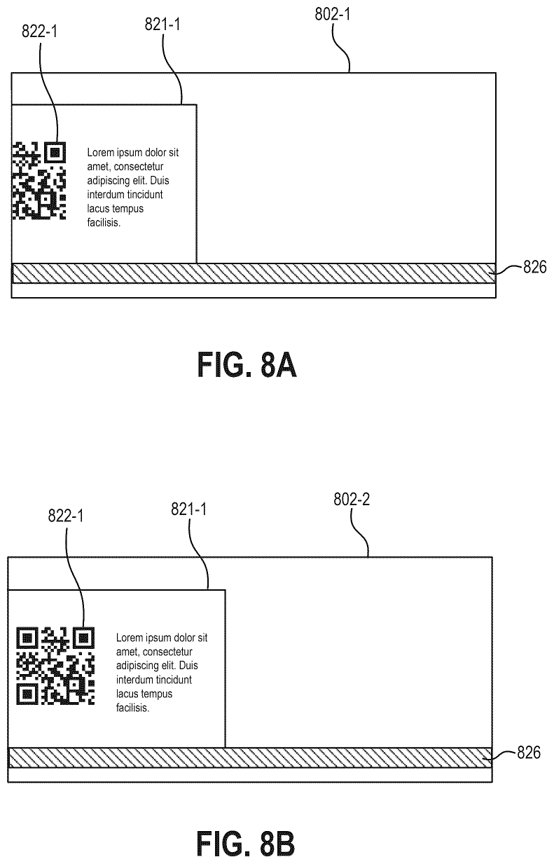

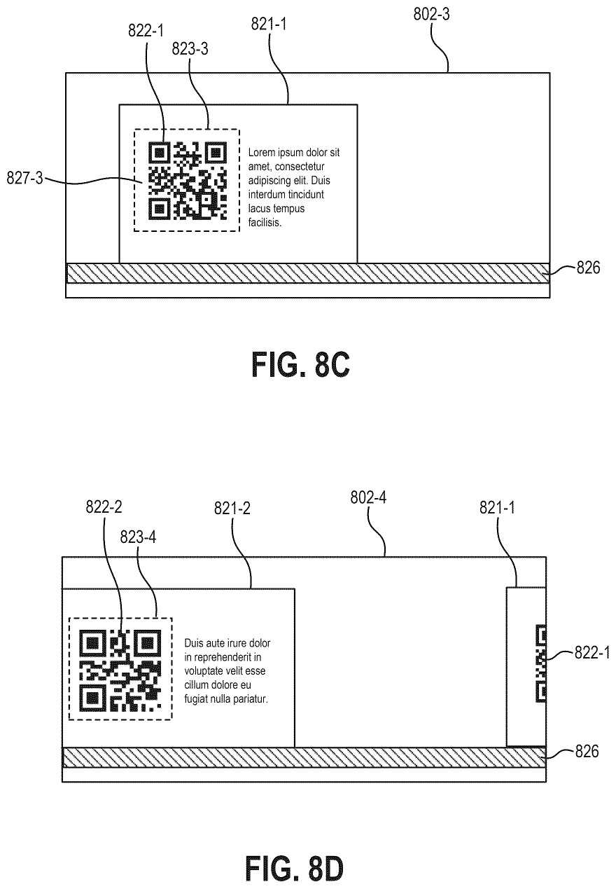

FIGS. 8A through 8D illustrate an example showing how the pre-processing module 715 can dynamically determine the ROI for a plurality of images 802-1, 802-2, 802-3, 802-4 that are captured by the camera 701 as objects containing barcodes move on a conveyor belt 826 from left to right across the field of view of the camera 701. In the paragraphs that follow, the processing of the images 802-1, 802-2, 802-3, 802-4 by the pre-processing module 715 and the decoder 714 will be described. In this example, it will be assumed that the barcodes are moving at a substantially constant velocity relative to the barcode-reading device 700. It will also be assumed that the images 802-1, 802-2, 802-3, 802-4 are captured in chronological order. In other words, the first image 802-1 shown in FIG. 8A is captured before the second image 802-2 shown in FIG. 8B, which is captured before the third image 802-3 shown in FIG. 8C, which is captured before the fourth image 802-4 shown in FIG. 8D.

Reference is initially made to the first image 802-1 shown in FIG. 8A. A portion of a first object 821-1 is visible in the left half of the first image 802-1. The first object 821-1 includes a first barcode 822-1, which is also partially visible in the first image 802-1.

In this example, when the pre-processing module 715 processes the first image 802-1, the pre-processing module 715 defines the ROI of the first image 802-1 as the entire first image 802-1. In other words, the pre-processing module 715 sends the entire first image 802-1 to the decoder 714 for processing.

The decoder 714 processes the first image 802-1 and identifies the first barcode 822-1 in the first image 802-1. The decoder 714 also determines reference points 724 indicating where certain features of the first barcode 822-1 are located in the first image 802-1. For example, the decoder 714 can be configured to determine the coordinates of at least some of the corners of the first barcode 822-1 in the first image 802-1. In general, a barcode has four corners: the upper left corner, the upper right corner, the lower left corner, and the lower right corner. In this example, by processing the first image 802-1, the decoder 714 can determine the coordinates of the upper right corner and the lower right corner of the first barcode 822-1.

Reference is now made to the second image 802-2 shown in FIG. 8B. The first object 821-1 has moved a little farther to the right along the conveyor belt 826 so that the entire first barcode 822-1 is visible in the second image 802-2. The pre-processing module 715 once again defines the ROI of the second image 802-2 as the entire second image 802-2. In other words, the pre-processing module 715 once again sends the entire second image 802-2 to the decoder 714 for processing. The decoder 714 processes the second image 802-2, identifies the first barcode 822-1 in the second image 802-2, and determines reference points 724 indicating where certain features of the first barcode 822-1 are located in the second image 802-2. Because the entire first barcode 822-1 is visible in the second image 802-2, the decoder 714 can determine the coordinates of each of the four corners of the first barcode 822-1 in the second image 802-2.

Because the first barcode 822-1 is moving at a substantially constant velocity relative to the barcode-reading device 700 and the decoder 714 has determined reference points 724 (e.g., coordinates of corners) indicating where the first barcode 822-1 is located in at least two previously processed images 802-1, 802-2, the pre-processing module 715 can use these reference points 724 along with timestamps 725 corresponding to the images 802-1, 802-2 to estimate the velocity of the first barcode 822-1. Once the velocity of the first barcode 822-1 has been estimated, then the pre-processing module 715 can use the estimated velocity of the first barcode 822-1, as well as the size of the first barcode 822-1 (which is known because the entire first barcode 822-1 is visible in the second image 802-2), to predict the location of the first barcode 822-1 in a subsequently captured image.

Reference is now made to the third image 802-3 shown in FIG. 8C. The first object 821-1 has moved a little farther to the right along the conveyor belt 826. Unlike the previous two images 802-1, 802-2, the pre-processing module 715 does not send the entire third image 802-3 to the decoder 714 for processing. Instead, the pre-processing module 715 determines the ROI 823-3 for the third image 802-3 based on the shape and size of the first barcode 822-1 and the predicted location of the first barcode 822-1 in the third image 802-3. In other words, the shape and size of the ROI 823-3 is selected so as to substantially match the shape and size of the first barcode 822-1 (but also including a tolerance area 827-3, as discussed below), and the location of the ROI 823-3 in the third image 802-3 is selected so as to encompass the predicted location of the first barcode 822-1 in the third image 802-3.

To account for potential errors in the predicted location of the first barcode 822-1, the ROI 823-3 can include a tolerance area 827-3. In other words, the size of the ROI 823-3 can be somewhat larger than the size of the first barcode 822-1. If the predicted location of the first barcode 822-1 is slightly off, the tolerance area 827-3 makes it more likely that the actual location of the first barcode 822-1 in the third image 802-3 will fall within the ROI 823-3. In some embodiments, the size of the tolerance area 827-3 can be pre-defined and applied across a plurality of images. This ensures a consistent buffer or margin around the predicted location of the barcode 822-1. In some embodiments, the size of the tolerance area 827-3 can be a user configurable parameter.

In subsequent images, the ROI can follow the barcode 822-1 as the barcode 822-1 moves from left to right within the field of view of the camera 701. When the barcode 822-1 exits the field of view of the camera 701, the pre-processing module 715 can reset the ROI to the entire image (i.e., so that the entire image is sent to the decoder 714 for processing).

In the example just described, the pre-processing module 715 estimates the velocity of the barcode 822-1. Alternatively, the velocity of the barcode 822-1 can be determined through other means and communicated to the barcode-reading device 700. For example, if the conveyor belt 826 is configurable so that its velocity can be set to a particular value, then the user can determine the velocity of the barcode 822-1 by setting the velocity of the conveyor belt 826. The user can then provide the velocity of the barcode 822-1 to the barcode-reading device 700 as input.

As noted above, under some circumstances the ROI for a captured image can be based on the barcode presentation rate (i.e., the rate at which new barcodes appear in the field of view of the camera 701), particularly when the barcode presentation rate is substantially constant. The barcode-reading device 700 can determine the barcode presentation rate in various ways. In some embodiments, the barcode-reading device 700 can estimate the barcode presentation rate by processing a plurality of images and determining how much time elapses between the presentation of new barcodes in the field of view of the camera 701. In other embodiments, the barcode presentation rate can be determined by the user and provided to the barcode-reading device 700 as input.

In the present example, it will be assumed that the barcode presentation rate is substantially constant and known to the barcode-reading device 700. It will also be assumed that the size, shape, and placement of barcodes is substantially consistent across different objects.

Reference is now made to the fourth image 802-4 shown in FIG. 8D. The first object 821-1 has moved to the right along the conveyor belt 826 so that the first object 821-1 (including the first barcode 822-1) has almost exited the field of view of the camera 701. A second object 821-2 with a second barcode 822-2 has entered the field of view of the camera 701 and is visible in the left side of the fourth image 802-4.

The pre-processing module 715 determines the ROI 823-4 for the fourth image 802-4 based at least in part on the barcode presentation rate. In other words, because the barcode presentation rate is substantially constant, the pre-processing module 715 can predict when the second barcode 822-2 will appear in the field of view of the camera 701. In addition, because the size, shape, and placement of barcodes is substantially consistent across different objects, the pre-processing module 715 can predict where the second barcode 822-2 will be located when it appears in the field of view of the camera 701. The pre-processing module 715 can take all of these factors into account when determining the ROI 823-4 for the fourth image 802-4.

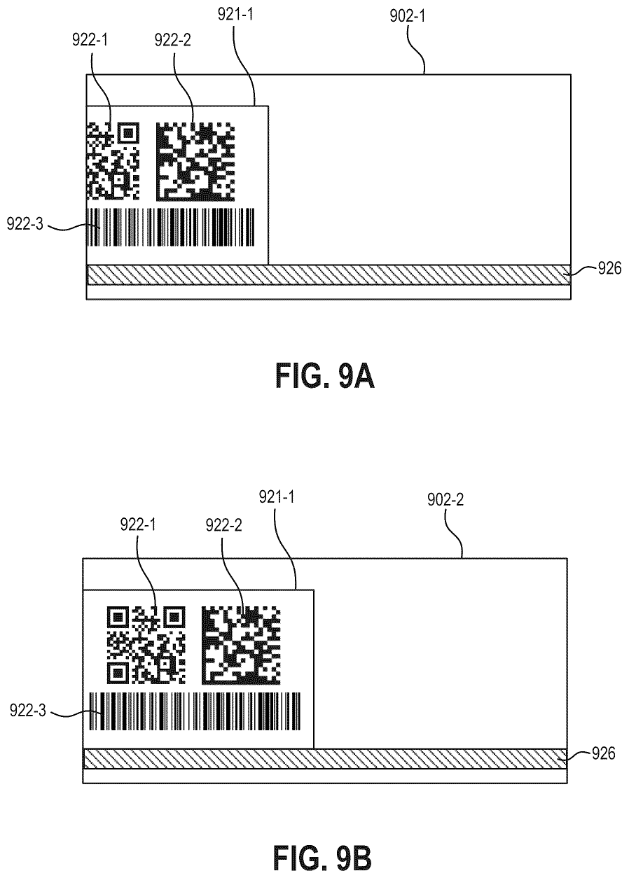

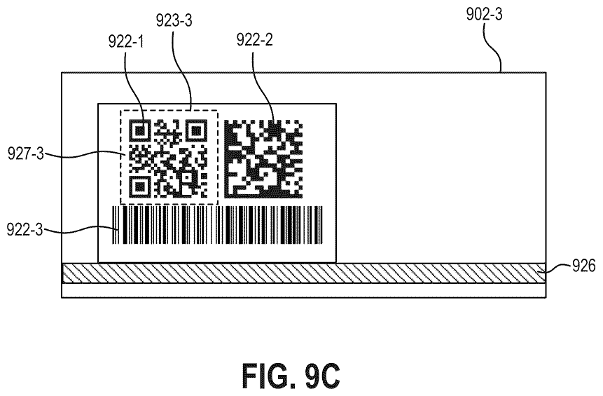

FIGS. 9A through 9C illustrate another example showing how the pre-processing module 715 can dynamically determine the ROI for a captured image 702. This example is similar in some respects to the example that was just described in connection with FIGS. 8A through 8D. In this example, however, the objects that are moving across the conveyor belt 926 include a plurality of barcodes. As noted above, in such a scenario, the user can specify characteristic(s) of a desired barcode (e.g., symbology), and the pre-processing module 715 can set the ROI so that it includes the desired barcode and excludes other barcodes.

Reference is initially made to the first image 902-1 shown in FIG. 9A. A portion of the first object 921-1 is visible in the left half of the first image 902-1. The first object 921-1 includes three different barcodes: a first barcode 922-1, a second barcode 922-2, and a third barcode 922-3. The first barcode 922-1 and the third barcode 922-3 are partially visible in the first image 902-1. The second barcode 922-2 is fully visible in the first image 902-1.

The barcodes 922-1, 922-2, 922-3 on the first object 921-1 are encoded in accordance with different barcode symbologies. In particular, the first barcode 922-1 is encoded in accordance with the QR code symbology, the second barcode 922-2 is encoded in accordance with the Data Matrix symbology, and the third barcode 922-3 is encoded in accordance with the UPC symbology. In the present example, it will be assumed that the user has specified (e.g., via user input to the barcode-reading device 700) that (i) barcodes encoded in accordance with the QR code symbology should be decoded, and (ii) barcodes encoded in accordance with other symbologies should not be decoded.

The pre-processing module 715 defines the ROI of the first image 902-1 as the entire first image 902-1. In other words, the pre-processing module 715 sends the entire first image 902-1 to the decoder 714 for processing. The decoder 714 processes the first image 902-1 and identifies the barcodes 922-1, 922-2, 922-3 in the first image 902-1. The decoder 714 also determines that the first barcode 922-1 is encoded in accordance with a symbology that should be decoded, whereas the second barcode 922-2 and the third barcode 922-3 are encoded in accordance with symbologies that should not be decoded. The decoder 714 also determines reference points 724 indicating where certain features (e.g., the upper right corner and the lower right corner) of the first barcode 922-1 are located in the first image 902-1.

Reference is now made to the second image 902-2 shown in FIG. 9B. The first object 921-1 has moved a little farther to the right along the conveyor belt 926 so that all of the barcodes are visible in the second image 902-2. The pre-processing module 715 once again defines the ROI of the second image 902-2 as the entire second image 902-2. In other words, the pre-processing module 715 once again sends the entire second image 902-2 to the decoder 714 for processing. The decoder 714 processes the second image 902-2, identifies the barcodes 922-1, 922-2, 922-3 in the second image 902-2, determines that the first barcode 922-1 should be decoded (and that the second barcode 922-2 and the third barcode 922-3 should not be decoded), and determines reference points 724 indicating where the four corners of the first barcode 922-1 are located in the second image 902-2.

Reference is now made to the third image 902-3 shown in FIG. 9C. The first object 921-1 has moved a little farther to the right along the conveyor belt 926. The pre-processing module 715 has estimated the velocity of the first barcode 922-1 using (i) the reference points 724 for the first barcode 922-1, determined by processing the first image 902-1 and the second image 902-2, and (ii) timestamps 725 corresponding to the first image 902-1 and the second image 902-2. The pre-processing module 715 has also used the estimated velocity of the first barcode 922-1 to predict the location of the first barcode 922-1 in the third image 902-3. The pre-processing module 715 determines the ROI 923-3 for the third image 902-3 based on the size, shape, and predicted location of the first barcode 922-1 in the third image 902-3. The ROI 923-3 also includes a tolerance area 927-3 to account for potential errors in the predicted location of the first barcode 922-1. The second barcode 922-2 and the third barcode 922-3 are excluded from the ROI 923-3 in the third image 902-3.

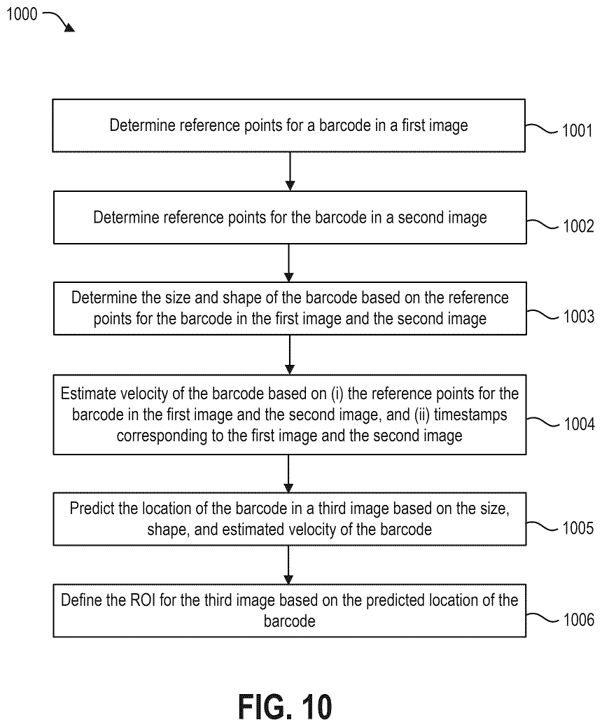

FIG. 10 is a flow diagram that illustrates another example of a method 1000 for dynamically determining the ROI for captured images 702. The method 1000 can be performed by the pre-processing module 715 within the barcode-reading device 700. In some embodiments, the method 1000 can be performed in response to user input that initiates barcode reading.

At 1001, the pre-processing module 715 determines one or more reference points 724 for a barcode in a first image (e.g., the first barcode 822-1 in the first image 802-1 or the first barcode 922-1 in the first image 902-1). At 1002, the pre-processing module 715 determines one or more reference points 724 for the barcode in a second image (e.g., the first barcode 822-1 in the second image 802-2 or the first barcode 922-1 in the second image 902-2). As indicated above, the reference points 724 can include the coordinates of certain features (e.g., corners) of the barcode.

At 1003, the pre-processing module 715 determines the size and shape of the barcode based on the reference points 724 for the barcode in the first image and the second image.

At 1004, the pre-processing module 715 estimates the velocity of the barcode based on the reference points 724 determined at 1001 and 1002 as well as timestamps 725 corresponding to the first image and the second image.

At 1005, the pre-processing module 715 predicts the location of the barcode in a third image (e.g., the first barcode 822-1 in the third image 802-3 or the first barcode 922-1 in the third image 902-3) based on the size, shape, and estimated velocity of the barcode. In other words, the pre-processing module 715 identifies a region of the third image where the barcode is predicted to be located based on the size, shape, and estimated velocity of the barcode.

At 1006, the pre-processing module 715 defines the ROI for the third image (e.g., the ROI 823-3 for the third image 802-3 or the ROI 923-3 for the third image 902-3) based on the predicted location of the barcode. For example, the pre-processing module 715 can define the ROI for the third image so that the ROI encompasses the predicted location of the barcode in the third image but does not encompass the entire third image. In some embodiments, the ROI can include a tolerance area (e.g., the tolerance area 827-3 or the tolerance area 927-3).

The techniques disclosed herein can be implemented in hardware, software, firmware, or any combination thereof, unless specifically described as being implemented in a specific manner.

At least some of the features disclosed herein have been described as instructions that are executable by a processor to perform various operations, actions, or other functionality. The term “instructions” should be interpreted broadly to include any type of computer-readable statement(s). For example, the term “instructions” may refer to one or more programs, routines, sub-routines, functions, procedures, modules etc. “Instructions” may comprise a single computer-readable statement or many computer-readable statements. In addition, instructions that have been described separately in the above description can be combined as desired in various embodiments.

The term “processor” should be interpreted broadly to encompass a general-purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term “memory” may refer to various types of processor-readable media such as random-access memory (RAM), read-only memory (ROM), non-volatile random-access memory (NVRAM), programmable read-only memory (PROM), erasable programmable read-only memory (EPROM), electrically erasable PROM (EEPROM), flash memory, magnetic or optical data storage, registers, etc. Memory is said to be communicatively coupled to a processor if the processor can read information from and/or write information to the memory. Memory that is integral to a processor is communicatively coupled to the processor.

The term “communicatively coupled” refers to coupling of components such that these components are able to communicate with one another through, for example, wired, wireless, or other communications media. The term “communicatively coupled” can include direct, communicative coupling as well as indirect or “mediated” communicative coupling. For example, a component A may be communicatively coupled to a component B directly by at least one communication pathway, or a component A may be communicatively coupled to a component B indirectly by at least a first communication pathway that directly couples component A to a component C and at least a second communication pathway that directly couples component C to component B. In this case, component C is said to mediate the communicative coupling between component A and component B.

The term “determining” (and grammatical variants thereof) can encompass a wide variety of actions. For example, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there can be additional elements other than the listed elements.

The phrase “based on” does not mean “based only on,” unless expressly specified otherwise. In other words, the phrase “based on” describes both “based only on” and “based at least on.”

As used herein, the term “substantially” means “to a great extent or degree,” emphasizing a closeness or approximation to a given characteristic, condition, or standard rather than an absolute or perfect adherence. When the term “substantially” is used to describe a particular characteristic, condition, or standard, it indicates that while the characteristic, condition, or standard may not be strictly or absolutely met, it is met to a degree that is reasonably and meaningfully close to that characteristic, condition, or standard. Specific thresholds might vary depending on the context or embodiment, but they can sometimes imply variations not exceeding certain percentages, such as 0.01%, 0.1%, 1%, 2%, 5%, or 10%, to illustrate the range of acceptable deviation. The term “substantially” can be applied across various contexts to signify an approximation that is practically or functionally equivalent to the ideal or described state.

The steps, operations, and/or actions of the methods described herein may be interchanged with one another without departing from the scope of the claims. In other words, unless a specific order of steps, operations, and/or actions is required for proper functioning of the method that is being described, the order and/or use of specific steps, operations, and/or actions may be modified without departing from the scope of the claims.

References to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A barcode-reading device, comprising:
a camera that is configured to capture images;
one or more processors;
memory that is communicatively coupled to the one or more processors;
a decoder that is stored in the memory and executable by the one or more processors to process captured images to decode barcodes; and
a pre-processing module that is executable by the one or more processors to dynamically determine a region of interest (ROI) for at least some of the captured images, wherein the ROI indicates what portion of a captured image is passed to the decoder for processing, and wherein the pre-processing module determines the ROI for a captured image based at least in part on a decoding marker in the captured image and an ROI definition that is associated with the decoding marker.

2. The barcode-reading device of claim 1, wherein the pre-processing module:
passes the ROI for the captured image to the decoder for processing; and
does not pass to the decoder one or more regions of the captured image outside of the ROI.

3. The barcode-reading device of claim 1, wherein:
the barcode-reading device comprises one or more aiming light sources; and
the decoding marker is a light beam that is projected onto the barcode by the one or more aiming light sources.

4. The barcode-reading device of claim 1, wherein the decoding marker is intrinsic to a medium on which a barcode is printed.

5. The barcode-reading device of claim 1, wherein the ROI definition varies based on the type of decoding marker.

6. The barcode-reading device of claim 1, wherein the ROI definition specifies a geometric shape of predefined size centered on the decoding marker.

7. The barcode-reading device of claim 1, wherein the ROI definition specifies a geometric shape and one or more offset values relative to the decoding marker.

8. The barcode-reading device of claim 1, wherein the ROI definition specifies a geometric shape that encompasses the decoding marker.

9. The barcode-reading device of claim 1, further comprising a user interface module that is executable by the one or more processors to receive user input defining the decoding marker and the ROI definition.

10. The barcode-reading device of claim 1, wherein the pre-processing module is additionally configured to cause the focus of the camera to be adjusted based on the location of the decoding marker within the captured image.

11. The barcode-reading device of claim 1, wherein the pre-processing module uses at least one of machine learning or optical character recognition to recognize decoding markers in captured images.

12. A barcode-reading device, comprising:
a camera that is configured to capture images;
one or more processors;
memory that is communicatively coupled to the one or more processors;
a decoder that is stored in the memory and executable by the one or more processors to process captured images to decode barcodes; and
a pre-processing module that is executable by the one or more processors to dynamically determine a region of interest (ROI) for at least some of the captured images, wherein the ROI indicates what portion of a captured image is passed to the decoder for processing, and wherein the pre-processing module determines the ROI for a captured image based at least in part on a predicted location of a barcode in the captured image.

13. The barcode-reading device of claim 12, wherein the pre-processing module is additionally executable by the one or more processors to predict the location of the barcode in the captured image based on the size of the barcode, the shape of the barcode, and an estimated velocity of the barcode.

14. The barcode-reading device of claim 13, wherein the pre-processing module is additionally executable by the one or more processors to estimate the velocity of the barcode based at least in part on:
reference points indicating where certain features of the barcode are located in previously processed images; and
timestamps corresponding to the previously processed images.

15. The barcode-reading device of claim 12, wherein the pre-processing module determines the ROI for the captured image so that the ROI encompasses the predicted location of the barcode in the captured image but does not encompass the entire captured image.

16. The barcode-reading device of claim 12, wherein the ROI for the captured image comprises a tolerance area such that the size of the ROI exceeds the size of the barcode in order to account for potential errors in the predicted location of the barcode.

17. The barcode-reading device of claim 12, wherein the pre-processing module:
passes the ROI for the captured image to the decoder for processing; and
does not pass to the decoder one or more regions of the captured image outside of the ROI.

18. The barcode-reading device of claim 12, wherein the barcode-reading device is configured for use in an environment where the barcodes move at a substantially constant velocity relative to the barcode-reading device.

19. The barcode-reading device of claim 12, wherein:
the barcode-reading device is configured for use in an environment where a barcode presentation rate is substantially constant; and
the pre-processing module defines the ROI for at least some captured images based at least in part on the barcode presentation rate.

20. The barcode-reading device of claim 12, wherein:
the captured image additionally comprises at least one other barcode in addition to the barcode; and
the pre-processing module defines the ROI so as to exclude the at least one other barcode from the ROI.
